(19) United States
(12) Patent Application Publication
(10) Pub. No.: US 2013/0275303 A1
(43) Pub. Date: Oct. 17, 2013

(54) METHOD AND SYSTEM FOR TWO STAGE AUTHENTICATION WITH GEOLOCATION

(71) Applicants: Michael Henry FIORE, Ridgefield, CT (US); Max Chion, Stamford, CT (US)

(72) Inventors: Michael Henry FIORE, Ridgefield, CT (US); Max Chion, Stamford, CT (US)

(73) Assignee: MasterCard International Incorporated, Purchase, NY (US)

(21) Appl. No.: 13/444,263

(22) Filed: Apr. 11, 2012

(51) Int. Cl. G06Q 20/40; G06Q 20/32

(52) U.S. Cl. 705/44

(57) ABSTRACT

Geographical location information provided by a mobile device is used to assist in providing a first authentication for payment transactions against a payment account number of a user. Mobile device identification is associated with a payment account number of the user such that the user is provided a first authentication for payment transactions against the payment account number when the mobile device has entered a premises of a merchant.

### FIELD

The present system and method relate to a two-stage authentication requirement for transactions against a payment account number. More specifically, the present disclosure relates to providing a first authentication for financial transactions against a payment account number of a user on a basis of location information of a mobile device associated with the payment account number of the user.

### BACKGROUND OF THE INVENTION

Financial transaction processing systems operate to facilitate transactions between at least a consumer (e.g., cardholder, user, etc.), an issuer (e.g., issuing bank of a payment card), and a merchant (e.g., store, shop, etc.). Payment cards (e.g., credit cards, debits cards, ATM (Automated Teller Machine) cards, etc.) are commonly used by a consumer/user, associated with a payment account number of the payment card, to engage in purchases of goods and services and/or other financial transactions at stores, shops, etc.

In recent years, an increase of electronic financial transactions in the marketplace has resulted in an increase fraudulent/unauthorized use of payment account numbers/payment cards. In fact, a significant portion of payment card fraud is counterfeit fraud, which involves counterfeit payment cards being used fraudulently at ATMs and/or points of sale (POS) terminals of merchants. Thus, a constant problem within the financial transaction industry is the management of fraud in the use of payment account numbers.

Various approaches have been previously implemented in an effort to address the above-noted problem. In one such approach, for example, approval or denial of a payment transaction is based on a co-location of a separate mobile device (e.g., cell phone) with geo-location capabilities and the specific point-of-sale (POS) terminal whereat the transaction is occurring. In such an approach, when a transaction, utilizing the transaction card of the user, is initiated, the physical location of the mobile device is determined and compared to the physical location of the point-of-sale (POS) terminal whereat the transaction is initiated. More specifically, when the transaction is initiated at the POS terminal, the physical location (e.g., latitude and longitude coordinates) of the POS terminal is determined based on information included in the transaction details (e.g., transaction amount and POS terminal identification). The physical (e.g., geographic) location of the mobile device (e.g., latitude and longitude coordinates of the mobile device) is then identified (to a varying level of accuracy) based on, for example, a geographic positioning system (GPS), mobile phone towers, Wi-Fi hot-spots, IP addresses, etc., or a combination thereof. The determined transaction location (e.g., physical POS location) and the determined physical location of the mobile device are then compared to determine if they are sufficiently close to one another. For example, the two locations are compared to determine if they are within a predetermined small range (e.g., distance threshold) of one another. In such an example, the predetermined small range could be 25 feet, 50 feet, etc. If the distance between the two locations is within the predetermined range, then the two locations are deemed sufficiently close to one another, and the transaction is approved. If however, the distance between the two locations exceeds the predetermined range, then the two locations are not considered sufficiently close to one another, and thus the transaction is denied. Thus, a mobile device, associated with a payment account number, must be co-located (within a predetermined distance) with the POS terminal at which a transaction is initiated.

While this approach offers a level of protection against fraud, it is limiting in various aspects. For example, in a merchant (e.g., department store) with a plurality of POS terminals, a determination of location must be made for each POS terminal within the merchant and for the mobile device upon a transaction initiation at each of the POS terminals within the merchant. In other words, at a merchant (e.g., Macy's, Sears, JCPenney, etc.) including a plurality of different departments, each including at least one POS terminal, a mobile device associated with the transaction card must be co-located with the POS whereat the attempted transaction is occurring. Hence, for a transaction to occur, it is necessary to determine the actual, current location of the mobile device as well as the access terminal where the attempted transaction is occurring. If a user were to initiate transactions with several different POS terminals within the same merchant, this requires multiple communications for each single transaction to occur in a short span of time, which requires intensive processing.

Thus, a need exists for an improved system and/or method for guarding against the unauthorized use of payment account numbers that leverages location based card control and overcomes the limiting aspects with respect to co-location of mobile devices and POS terminals.

### SUMMARY

Systems and methods for authenticating a cardholder, associated with a payment account number and a mobile device, upon entry to a merchant.

It is noted initially that, as used herein, the term “payment account number” is sometimes used interchangeably with financial transaction card number and means a financial account number of a cardholder, that is associated with, for example, a magnetic stripe bearing card, smart card, magnetic stripe and smart card combination, prepaid card, credit card, debit card, combination credit/debit card, Visa®, MasterCard®, American Express®, Diners Club, Discover® Card, merchant card, plastic or virtual card number (VCN), or nearly any other account number that facilitates a financial transaction using a transaction clearance system. VCNs and pre-paid card numbers and other financial transaction card number that can be generally viewed as being more readily issued and disposed of because they do not require the establishment of a line of credit, and therefore can be linked to various controls (amounts, cumulative amounts, duration, controls on spending by amounts, cumulative amounts, types of merchants, geographic controls, to name a few).

Also, as used herein, the terms “cardholder,” “card user,” “user,” and “card recipient” can be used interchangeably and can include any user making purchases of goods and/or services. Further, as used herein in, the term “card issuer” or can include, for example, a financial institution (i.e., bank) issuing a card, a merchant issuing a merchant specific card, a stand-in processor configured to act on-behalf of the card-issuer, or any other suitable institution configured to issue a financial card.

Some exemplary embodiments of the present disclosure involves a method for two-stage authentication of a user of a mobile device for a payment account number transaction. A financial transaction system associates, in a storage device of the system, at least one payment account number of a user with a mobile device of the user. The system also identifies a location of the mobile device at a merchant's physical location. Once the system has determined that the mobile phone of the user has entered a premises of the merchant, the system provides a first authentication of the user of the at least one payment account number for payment transactions with the merchant against the payment account number. In addition to providing a first authentication, the system is configured to receive a second authentication, which is provided by the user as part of a payment transaction against the at least one payment account number associated with said mobile device at said merchant.

Other exemplary embodiments of the present disclosure involves a financial transaction system for two-stage authentication of a user of a payment account number. The system includes a mobile device of a user and a managing computer system. The mobile device of the user is configured to transmit information regarding its geographic location. The managing computer system includes at least a storage device and a computer processing device. The storage device stores information that associates the mobile device of the user with at least one payment account number of the user. The computer processor is configured to receive the location information from the mobile device and identify a merchant whereat the mobile device is located. Once the merchant has been identified whereat the mobile device is located, the computer processing device is configured to provide a first authentication of the user of the at least one payment account number associated with the mobile device for payment transactions at the merchant against the at least one payment account number. The computer processing device is also configured to receive second authentication from the user as part of a financial transaction against the at least one payment account number associated with the mobile device at the merchant.

### BRIEF DESCRIPTION OF THE DRAWINGS

The exemplary embodiments of the disclosed systems and methods can be better understood with reference to the following drawings and description. The components in the figures are not necessarily to scale, emphasis instead being placed upon illustrating the principles of exemplary embodiments of the disclosed system. Moreover, in the figures, like elements are described with like reference numbers.

FIG. 1 illustrates a high level diagram of a financial transaction system architecture that may be employed according to an embodiment of the disclosed system.

FIG. 2 illustrates a block diagram illustrating bi-directional communication between a managing computer system of the financial transaction system of FIG. 1 and parties external to the managing computer system.

FIG. 3 illustrates components of a storage device of the managing computer system of FIG. 2.

FIGS. 4A-4B illustrate examples of authentication tables of the storage device of FIG. 3.

FIG. 5 is a flow chart illustrating a method for two-stage authentication of a user via the financial transaction system of FIG. 1. out.

Further areas of applicability of the present disclosure will become apparent from the detailed description provided hereinafter. It should be understood that the detailed description and exemplary embodiments are intended for purposes of illustration only and that the claimed invention is not limited to these particular embodiments but rather fully encompasses variations and modifications which may occur to those skilled in the art.

### DETAILED DESCRIPTION OF THE DRAWINGS

At the onset, it is noted that the present disclosure may refer to structural and/or functional components, protocols, communication standards, etc., that are commonly known in the art without describing their configuration and/or operation in detail except for their applicability with respect to the present disclosure.

The disclosed embodiment include a financial transaction system that provides two stages of authentication of a user/cardholder of a payment account number/transaction card. The system includes a managing computer system configured to provided a first authentication of a user of a payment account number (PAN), for attempted financial transactions at a merchant against the payment account number (PAN), when a mobile device of the user has entered a premises of the merchant. The managing computer system is further configured to receive a second authentication from the user as part of a financial transaction against the PAN.

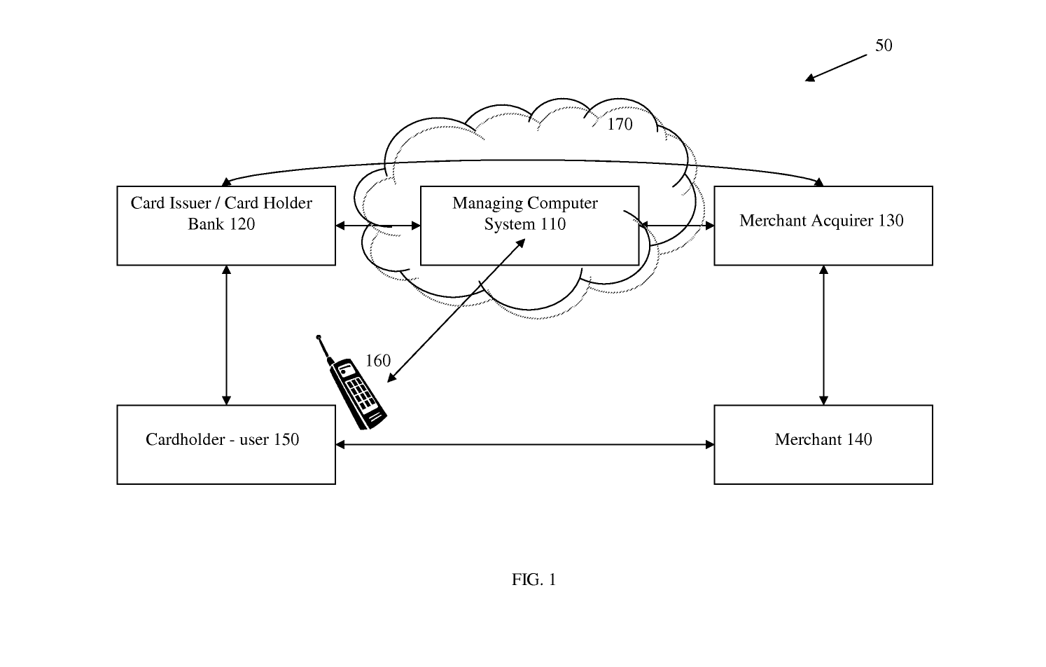

FIG. 1 illustrates a financial transaction system 50 including a card issuer 120, a cardholder/user 150, a mobile device 160 of the user 150, a merchant 140, and a management platform (e.g., financial managing computer system 110) for two-stage authentication according to an embodiment of the disclosed system. It will be apparent to persons having skill in the relevant art(s) that the financial transaction system 50 (while not illustrated) may be configured to include multiple mobile devices and multiple merchants.

The card issuer 120, such as an issuing bank or other financial institution, is configured to issue a payment card to the user 150. It should be understood that the card issuer 120 may issue a physical card, or only virtual cards, and may set a limit (e.g., a credit limit, a transaction limit, a spending limit, etc.) for the payment card. In other embodiments, card issuer 120 may impose no preset spending limit for the payment card. It should be further understood that the payment card may represent the “real” payment account number (PAN), or may alternatively be a virtual payment card, and may have additional controls set by a user, generally known as a controlled payment number (CPN). In some embodiments, a virtual payment number (VPN) may be associated with the real payment account number (PAN) such that the virtual payment number is a stand-in or pseudo-card (whether also in physical form or only a virtual payment number) that have additional controls on use either set up by the payment card account issuer 120, or by the customer 150, or by both. These additional controls (as identified above as individual controls or as parts of personal or location-based profiles) limiting the use of the payment card numbers are in addition to the regular payment card authorization process.

The user 150, such as the cardholder or other authorized user of the payment card (e.g., payment account number) may choose to use the payment card in an attempt to engage in a financial transaction with the merchant 140 (e.g., attempt to purchase goods and/or services). The payment card used by the user 150, as discussed above, may be issued to the user 150 by the card issuer 120.

The mobile device 160 is provided with a software application that enables cardholders/users 150 to access the managing computer system 110 to register mobile devices and or provide location information. Such software applications can be installed on the mobile device 160 by the user 150 of the mobile device 160 or can be installed by the manufacture of the provider of the mobile device 160. In some embodiments, a mobile device application enables users to register one or multiple mobile devices 160 into the managing computer system 110 and enable the mobile device 160 to transmit geo-location based information to managing computer system 110. In other embodiments, the mobile device application enables users to link (i.e., associate) one or more mobile devices 160 to one or multiple PANs of payment cards. In yet other embodiments, the mobile device application enables users to manually enter the physical location of the mobile device 160 or to enter a merchant 140 whereat the mobile device 160 is located.

The mobile device 160 of the user 150 also includes electronics capable of determining its current geographic location and is configured to communicate with the managing computer system 110. In particular, the mobile device 160 is configured to transmit, to the managing computer system 110, information pertaining to its current physical/geographic location and/or information pertaining to a merchant location whereat the mobile device 160 is located (preferably upon entering a premises of the merchant 140). The mobile device 160 can communicate the information regarding its current geographic location to the managing computer system 110 through any form of network or communication protocols including TCP/IP of the Internet or a private network through the Internet, SMS messages, over the cellular telephone system, e-mail messages over the Internet or a private network, and any form of point-to-point communication, whether encrypted or otherwise, as examples.

The mobile device 160, for example, may include the ability to use a geographic positioning system (GPS), or to estimate its position by being in the range of a wireless (e.g. 802.11 or Wi-Fi) local area network transmitter of a merchant, or triangulate its position by using the transmissions of Wi-Fi transmitters, the position of which is known or can be derived from either to the managing computer system 110, by the mobile device 160, or by the Wi-Fi transmitters which transmit their location information to the mobile device 160. Alternatively or additionally, the mobile device 160 may be able to determine its geographic location based on transmissions from cellular phone communication providers via cell towers (either by being in the coverage area of one or triangulating its position from three or more cellular transmitters) and the like which either transmits the location of the cellular communication transmitters so that the mobile device can determine its own location based thereon, or conveys to the mobile device 160 the location as determined by the cellular system as to the location of the mobile device 160.

Additionally, there are a variety of systems and methods that may be used in order to locate the mobile device 110. Various systems that may be used to locate the mobile device 110 include, for example, GPS, Wi-Fi, (both discussed above), radio-frequency identification, Bluetooth, magnetic field detection, sound-based detection, bar codes (e.g., one-dimensional bar codes, or two-dimensional bar codes, such as a QR code, etc.), or device recognition (e.g., MAC address recognition).

In some embodiments, the mobile device 160 can be provided with an application to open a communication channel or channels to the managing computer software 110, and optionally that would permit the user 150 to enter the current location of the mobile device 160 (e.g., the merchant 140 at which the mobile device 160 is located). In some embodiments, for example, upon detection of wireless area networks of merchants, the mobile device 160 is configured to provide a menu (e.g., a drop down menu) from which the user 150 can select the particular merchant whereat the mobile phone 160 is located. In other embodiments, for example, the mobile device 160 is configured to scan an item at a particular merchant, e.g., via a bar code (mentioned above) of the item, and is configured to then transmit information regarding the merchant whereat the item is on sale, thereby indicating the location of the mobile phone.

In yet other embodiments, the mobile device 160 is configured to determine when the mobile device 160 is crossing or has crossed a physical threshold, e.g. a store entrance. Said another way, the mobile device 160 is configured to determine when the mobile device 160 has entered a premises of a particular merchant and when the mobile device has exited a premises of the particular merchant. Various techniques may be employed for such detection including, for example, rapid degradation of GPS signals, rapid improvement of the WiFi signal, a combination of GPS signal degradation and WiFi signal improvement, a sudden decrease of location data accuracy, sound identification (ultrasonic and/or sound pattern recognition), magnetic field detection, RF signal detection, barcode recognition, recognition of device IDs, manual data entry, and/or other methods.

With respect to the mobile device 160, it should be noted that the mobile device 160 can be any form of mobile communication device having geo-location capabilities, including but not limited to wireless mobile devices such as a cellular telephones, wireless e-mail devices such as a Blackberry®, personal digital assistants, laptops with a wireless communication card, or nearly any other form of past or present or future mobile communication device that would be associated with and likely carried by a customer when making or initiating a payment card transaction. A customer 150 who owns or controls the mobile device 160 would be able to selectively enable or disable the mobile device 160 from providing a current geographic location to the managing computer system 110 if for no other reason than customer preference or privacy concerns.

The merchant 140 is configured to accept the PAN (e.g., payment card) for payment of a financial transaction (e.g., attempted purchase of goods and services), to process the PAN (e.g., at the merchant point-of-sale terminal), and to transmit transaction details directly to the managing computer system 110 or indirectly via the merchant acquirer 130 (e.g., an acquiring bank). The transaction details may be provided in an authorization request, which may originate at the merchant 14 or at the acquirer 130.

The merchant acquirer 130 is configured to receive transaction details from a merchant 140 and to transmit the transaction details to the managing computer system 110. The merchant acquirer 130 is further configured to communicate with the card issuer 120. The merchant acquirer 130 may be, for example, an acquiring bank or other financial institution that operates for or on behalf of the merchant 140 for the purpose of processing payment card transactions and communicating with the card issuer 120. While the merchant acquirer 130 typically communicates information between the managing computer system 110 and the merchant 140, those skilled in the art, would recognize that the merchant acquirer 130 need not be involved in certain transaction types and depending on the card processing network.

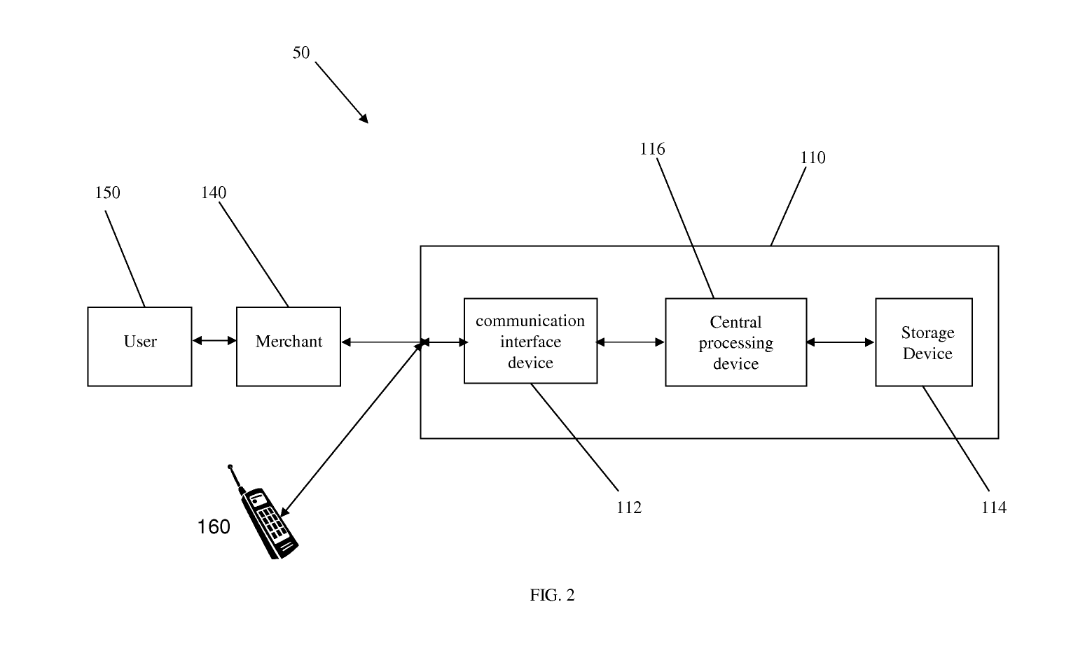

The managing computer system 110 includes at least a communication interface device 112, a computer processing device 116 and a memory device (e.g., storage device 114), as depicted in FIG. 2. The managing computer system 110 can be implemented in a communications network environment 170 is configured to communicate, directly or indirectly, via the communication network 170, with the user 150, the mobile device 160, the merchant 140, the card issuer 120 and the merchant acquirer 130. The communication network 170 can be any suitable communications network configured to support electronic financial transactions (e.g., debit, credit, automated teller machine (ATM) transactions, etc.). Suitable communication networks include, but are not limited to, a wide area network (WAN), a local area network (LAN), the Internet, Wi-Fi, fiber optic, coaxial cable, infrared, radio frequency, near field communication, or any other type of network that may be suitable for performing the functions discussed herein as will be apparent to persons having skill in the relevant art.

Moreover, it will be appreciated that communications regarding financial transactions (e.g., payment account number transactions, payment card transactions, etc.) can be made through legacy or a future iteration of the communication network 170.

The managing computer system 110 is configured to receive authorization requests from a merchant 140, typically through the merchant acquirer 130, for authorization of attempted financial transactions (e.g., purchases of goods and services) against a PAN of the user 150. In the disclosed embodiments, a physical transaction location of the merchant 140 (e.g., a store, bank, shop, restaurant, etc.), at which a transaction card (e.g., payment account number) is selectively used by the user 150 in an attempt to conduct a financial transaction. For example, the physical transaction location can include a card reader, e.g., a point-of-sale (POS) terminal (not illustrated), in which the payment card (payment account number) is read (e.g., swiped, scanned, etc.), or at which the payment account number (associated with the payment card) is entered.

As provided above, and as depicted in FIG. 2, the managing computer system 110 includes at least the communication interface device 112, the computer processing device 116 and the memory device (e.g., storage device 114).

The communication interface device 112 of the managing computer system 110, as illustrated in FIG. 2) provides one or more communications paths from the managing computer system 110 to and from other electronic devices and/or computer systems. While FIG. 2 illustrates the managing computer system 110 in communication with the merchant 140 and the mobile device 160, the managing computer system 110 is also configured to communicate with other devices and/or systems such as the merchant acquirer 130 and card issuer 120 (shown, for example, in FIG. 1). The communication paths provided by the communication interface device 112 can include, for example, one or more communication networks 170 (discussed above and shown in FIG. 2) or can include remote device communication lines, wireless connections, etc. The communication interface device 112 is configured to receive, from a the merchant 140 (or merchant acquirer 130 as shown in FIG. 1) information pertaining to an electronic financial transaction and to communicate the transaction information to other devices/modules of the financial transaction system 50.

The computer processing device 116 of the managing computer system 110 is configured to receive the financial transaction information from the merchant 140 (or merchant acquirer 130 shown in FIG. 1) via the communication interface device 112 and to communicate with the storage device 114. The computer processing device 116 may be, for example, in the form of a stand-alone computer, a distributed computing system, a centralized computing system, a network server with communication modules and other processors, or nearly any other automated information processing system configured to communicate with merchants 140 and mobile devices 160.

The computer processing device 116 is configured to receive location information from the mobile device 160, via communication interface device 112, and communicate with the storage device 114 to access data stored therein in order to identify the mobile device 160 (associated with the PAN against which a request for authorization has been received from the merchant 140) and to identify a location of the mobile device 160 (e.g., a location of a particular merchant). The computer processing device 116 is further configured to provide a first authentication of the user, either voluntary or involuntary (as discussed in more detail herein) of the PAN (associated with the payment card and the mobile device 116) for attempted financial transactions (e.g., attempted purchases of goods and/or services) at the merchant 140 against the PAN, when the mobile device 160 of the user has entered a premises of the merchant 160. In other words, when the computer processing device 116 of the managing computer system 110 has determined and/or identified that the mobile device 160 has entered a premises of the merchant 140 (e.g., is on the property/grounds of the merchant 140), based on information received by the mobile device 160 and, in some embodiments, information stored in the storage device 114 (discussed in more detail herein), the computer processing device 116 is configured to provide a first authentication (e.g., pre-authentication) for financial transactions against the PAN with the merchant 140.

The computer processing device 116 is further configured to receive a second authentication (e.g., from the user) as part of a payment transaction against the PAN associated with the mobile device 160 at said merchant 140. The second authentication is a voluntary authentication and can include, for example, swiping the payment card (associated with the PAN) at the POS, a credit tap, etc.

The storage device 114 of the managing computer system 110 is configured to store a variety of information pertaining to the managing computer system 110 and parties/devices external to the managing computer system 110 (e.g., merchants, mobile devices, etc.). The storage device 114, while illustrated in FIG. 2 as being external to the computer processing device 116, can in alternative embodiments, be implemented within the computer processing device 116. Moreover, while FIG. 2 illustrates the storage device 114 as being implemented within the managing computer system 110, in some embodiments, can be external to, but in communication with, the managing computer system 110. Furthermore, while the storage device 114 is illustrated in FIG. 2 as being a single device, in some embodiments, the managing computer system 110 can include a plurality of storage devices. Moreover, the memory device can include any form of data storage device including, but not limited to, of short term, long term, volatile, nonvolatile, electronic, magnetic, optical recording mechanisms, combinations thereof or any other suitable non-transitory computer-readable storage medium capable of storing data which associates identification information of individual mobile devices such as mobile device 160 associated with a user 150 with individual payment card accounts (payment account numbers) of payment cards issued to the user 150 by a card issuer 120.

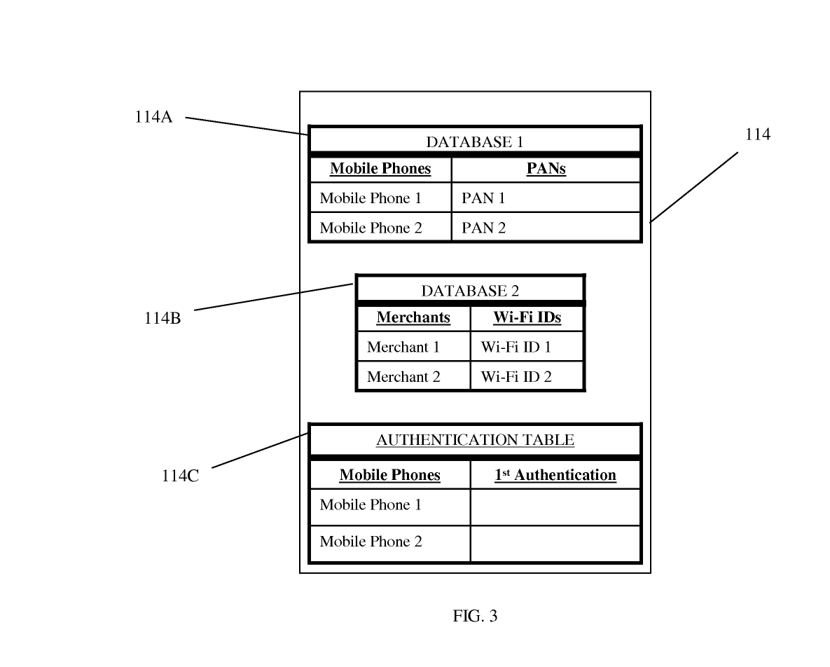

The storage device 114 comprises at least one database and an authentication table. In some embodiments, as illustrated, for example, in FIG. 3, the storage device includes a first database 114A (DATABASE 1), a second database 114B (DATABASE 2), and authentication table 114C. The storage device 114 is configured to receive electronic financial transaction information (transmitted by the merchant 140) and instructions to add or delete a merchant location whereat first authentication is provided for a user 150 of a mobile device 160 (discussed in more detail herein).

The first database 114A stored within the storage device 114 stores information associated with a plurality of mobile devices and payment account numbers (PANs). More specifically, the first database 114A is configured to associate/link information associated with a mobile device 160 of a user 150 with at least one payment account number (PAN) of a payment card of the user 150. FIG. 3 illustrates an example of two mobile devices from the plurality of mobile devices (not illustrated) stored within the first database 114a. In the example of FIG. 3, mobile phone 1 is associated with payment account number (PAN) 1, and mobile phone 2 is associated with PAN 2. As discussed above, a software application on the mobile phones 1, 2, enable the user of the phones to access the managing computer system 110 to register their mobile devices and associate/link their mobile devices with one or more PANs. In alternative embodiments, the card issuer 120 is configured to access the managing computer system 110 to associate/link the PANs of an issued payment card to the user 150.

The second database 114B stored within the storage device 114 stores information associated with merchants, e.g., merchant identification (ID) and their wireless local area networks (e.g., Wi-Fi), e.g., Wi-Fi IDs. More specifically, the second database 114B is configured to associate each registered merchant with their respective Wi-Fi IDs. In the example of FIG. 3, information (IDs) with respect to two merchants (Merchant 1 and Merchant 2, respectively) from a plurality of merchants (not illustrated) are stored within the second database 114B and associated with respective Wi-Fi/WLAN IDs (Wi-Fi ID 1 and Wi-Fi ID 2, respectively) of the merchants.

The authentication table 114C stored within the storage device 114 stores information (e.g., mobile telephone numbers, IP addresses, etc.) associated with the plurality of mobile devices 160 and merchants (e.g., store ID) to which first authentication has been provided. In other words, upon detecting and determining a physical location of the mobile device 160 and a merchant 140 whereat the mobile device 160 is located, the storage device 114 receives instructions from the computer processing device 116 to store and identify, within the authentication table 114C, a merchant 140 whereat the mobile device 160 is located such that first authentication (e.g., pre-authentication) is provided for transactions against the PAN, associated with the mobile device (as stored in the first database 114A). The authentication table 114C continues to identify the merchant 140 whereat the mobile device 160 is located (for first authentication purposes) until the storage device 140 receives instruction to remove the identity of the merchant 140 from the authentication table 114. Such instructions can be based, for example, upon location of the mobile device 160 (e.g., exiting the premises of the merchant, entering the premises of a different merchant).

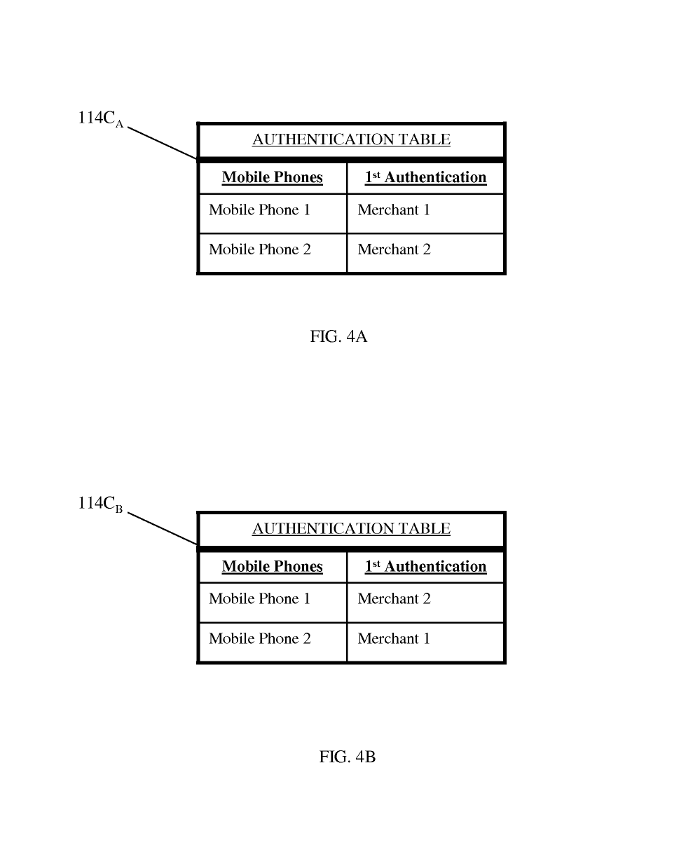

FIGS. 4A-4B illustrate exemplary embodiments of authentication tables stored in the storage device 114 of FIG. 3 including indication/identification of merchants whereat users of PANs associated with mobile phones have been provided first authentication. With respect to FIG. 4A, an authentication table 114C_{A} is illustrated identifying specific merchants whereat users of PANs associated with mobile phone 1 and mobile phone 2 have been provided first authentication. For example, a user of the PAN 1 associated with mobile phone 1 (as stored in the first database depicted in FIG. 3) has been provided first authentication for financial transactions at Merchant 1. First authentication for transactions against PAN 1 may be provided on a basis of, for example, the mobile device 160 of the user entering the premises of Merchant 1 and detecting a wireless local area network (Wi-Fi) of Merchant 1. In such an example, managing computer system 110 receives information from the mobile device 160 including information identifying the Wi-Fi/WLAN of the merchant 140. The storage device 114 identifies Merchant 1, whereat the mobile device 160 is located, from the second database 114B (based on the information received from the mobile device 160, e.g., Wi-Fi ID 1) and further identifies Merchant 1, in the authentication table 114C, for which the PAN, associated with the mobile device 160, is provided first authentication.

In another embodiment, first authentication for transactions against PAN 1 may be provided on the basis of, for example, scanning, with the mobile device 160, a store/merchant item (e.g., a bar code) of Merchant 1, which identifies Merchant 1. This identifying information is received by the managing computer system 110, which then identifies Merchant 1 and provides first authentication in a manner similar to that discussed above.

In yet other embodiments, the user also manually enter, via the mobile device 160, Merchant 1 as the merchant location of the mobile device 160. In such an example, the mobile device 160 may detect several Wi-Fi's/WLAN of merchant (for example, if the mobile device is within a mall or shopping plaza), and provide a menu (e.g., pull-down) on a display of the mobile device 160, for user 150 selection, of the merchants with Wi-Fi signals detected by the mobile device 160. The user may then select Merchant 1 as the merchant location of the mobile device 160.

The authentication table 114Ca of FIG. 4A further illustrates that a user of PAN 2 associated with mobile phone 2, as stored in the first database of FIG. 3, has been provided first authentication for financial transactions at Merchant 2. First authentication for the user of PAN 2 is provided in manner similar to that with respect to PAN 1, based upon location of the mobile device associated with the user.

A change in first authentication (from FIG. 4A) is illustrated in FIG. 4B. For example, in FIG. 4B, the authentication table 114C_{B} provides that first authentication for the user associated with PAN 1 (which is associated with mobile device 1) is now provided for transactions at Merchant 2 (previously pre-authenticated at Merchant 1). Similarly, first authentication for the user associated with PAN 2 (which is associated with mobile device 1) is now provided for transactions at Merchant 1 (previously pre-authenticated at Merchant 2). With respect to mobile phone 1, when mobile phone 1 existed the premises of Merchant 1, first authentication for attempted transactions at Merchant 1 was revoked (i.e., Merchant 1 is removed from authentication table). However, upon entering the premises of a new merchant (e.g., Merchant 2), first authentication for PAN 1 associated with mobile phone 1 is then provided from transactions at Merchant 2. Similarly, with respect to mobile phone 2, when mobile phone 2 existed the premises of Merchant 2, first authentication for attempted transactions at Merchant 2 was revoked (i.e., Merchant 2 is removed from authentication table). However, upon the mobile phone 2 entering the premises of a new merchant (e.g., Merchant 1), first authentication for PAN 2 associated with mobile phone 2 is then provided for transactions at Merchant 1. The new merchant location a mobile phone is detected (and first authentication granted with respect to the new location) in manners similar to those discussed above. For example, by Wi-Fi-detection, by the physical scanning of store/merchant items (e.g., via bar codes), manually entering, e.g., via a menu on the mobile device (e.g., drop-down menu) of the merchants, among others.

It is further noted that the removal or the revocation of first authentication can be based on, for example, a detection of the mobile device 160 exiting the premises of the merchant 140. In such an example, the mobile device 160 may detect that the Wi-Fi signal of the merchant 140 is not as strong (e.g., the mobile device is losing detection of the Wi-Fi signal). In another example, the mobile device 160 may no longer detect the Wi-Fi signal of the merchant (e.g., out of range). In another embodiment, removal or revocation of first authentication can be based on inactivity at the merchant 140. For example, the managing computer system 110 may allow a user 150 to store/indicate (in the storage device 114) a specific amount of time in which first authentication is provided for transactions at any given merchant. In other words, once a mobile phone 160 has entered the premises of a particular merchant 140 and first authentication has been provided for transactions at that particular merchant 140, if the predetermined amount of time lapses without any activity at the merchant 140 with respect to the associated PAN, first authentication can be revoked. In yet another embodiment, removal or revocation of first can be based on the managing computer system 110 receiving information with respect to a new physical merchant location of the mobile device 160. In such an example, if the mobile device 160 is within a shopping mall wherein merchants/stores are relatively close to one another, a new physical location may be received for example, by the manual input of the user 150 of the mobile device 160.

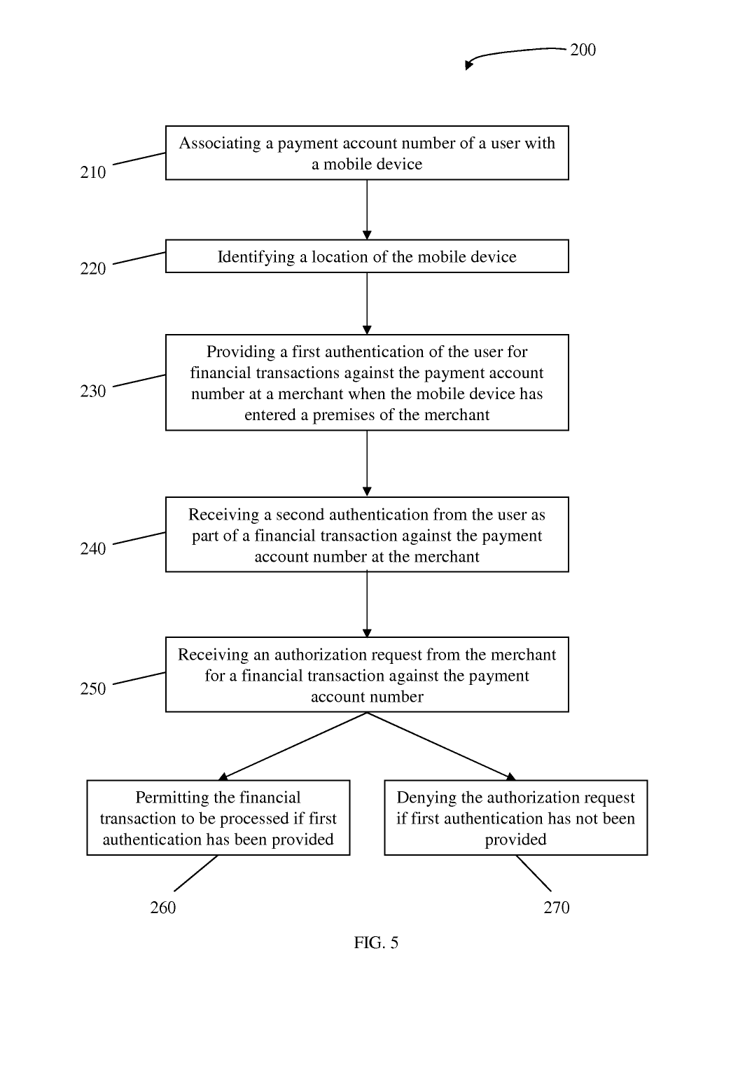

FIG. 5 illustrates a flow chart 200 demonstrating a method of two-stage authentication via the financial transactions system 50 of FIG. 1. At step 210, the managing computer system 110 (via storage device 114) associates/links a payment account number (PAN) of a user/cardholder 150 with a mobile device 160 of the user 150 (as illustrated, for example, in FIG. 3), and later identifies at least one mobile device associated with a payment account number (PAN) against which a request for authorization (from a merchant 140) has been received, by accessing data stored in the storage device 114. Specifically, a user 150 (via a software application on the mobile device 160 of the user 150) may access the managing computer system 110 in order to link/associate a PAN (of a payment card) with a mobile device 160 (e.g., internet protocol (IP) address of the device, serial number, etc.) of the user 150. Such devices can include, for example, wireless mobile devices such as a cellular telephones, wireless e-mail devices such as a Blackberry®, personal digital assistants, laptops with a wireless communication card, etc. Upon receiving a request for authorization from a merchant 140 (discussed herein below), the managing computer system 110 identifies the mobile device 160 associated with the PAN used in the attempted transaction.

At step 220, the managing computer system 110 identifies a location of the mobile device 160 by receiving location information from the mobile device 160. In some embodiments, the location information includes information regarding Wi-Fi signals that the mobile phone 160 detects. In such embodiments, the managing computer system 110 identifies, via storage device 114 (second database 114B) merchants associated with the detected Wi-Fi signals. In other embodiments, the location information includes latitude and longitude coordinates of the mobile device (to a varying level of accuracy) based on, for example, geographic positioning systems (GPS) of the mobile device. In yet other embodiments, location information can include, for example, a specific merchant (e.g., Macy's, Sears, JCPenneys, etc.), as provided by the user. In some embodiments, the managing computer system 110 is configured to identify a specific location of the mobile device 160 based on a combination of the above.

At step 230, first authentication is provided to the user 150 for financial transactions against the PAN (associated with the mobile device 160) at a merchant 140 when the mobile device 150 has entered a premises of the merchant 140. Specifically, based on the location information received from the mobile device 150, the managing computer system 110 determines a merchant 140 whereat the mobile device 160 is located and provides a first authentication for attempted purchases at that merchant 140. For example, if a user 150 (along with his/her mobile phone 160) enters a Macy's Department Store at the location of “5701 Duke Street, Alexandria, Va. 22304”. The managing computer system 110 receives location information from the mobile device 160, determines that the mobile device 160 is located at this particular Macy's Department Store location, and identifies this location for first authentication for transactions by the user 150 of the mobile phone 160. In other words, while the mobile device 160 is in Macy's Department Store (location—5701 Duke Street, Alexandria, Va. 22304), the user 150 is “pre-authenticated” (i.e., provided first authentication) for any transaction attempts made within the premises of this merchant location. Thus, once first authentication is granted, the user 150 is pre-authenticated for transactions at any POS terminal within the merchant 140. For example, since the user 150 has been pre-authenticated for purchases within this store/merchant location, the user 150 can initiate transactions in any department (e.g., Women's Apparel, Men's Apparel, Bed & Bath, etc.), without the need for first authentication to be provided individually for each POS terminal within the merchant 140.

At steps 240 and 250, the managing computer system 110 receives an authorization request from the merchant 140 for the a financial transaction against the payment account number of the user 150 and further receives a second authentication from the user 150 as part of a financial transaction against the payment account number. In some embodiments, the authorization request is routed to the managing computer system 110 either in parallel or through the card issuer 120. In other embodiments, the request can travel through the managing computer system 110 between the merchant acquirer 130 and the card issuer 120 or a hybrid of the two systems can be provided. Specifically, with respect to steps 240 and 250, a user 150 initiates a transaction (e.g., an attempted purchase of goods) at a POS terminal of the merchant 140 and has provided his/her second (voluntary) authentication (e.g., swing card, credit tap, signature, etc.). This second (voluntary) authentication is transmitted to the managing computer system 110 either concurrently or separately from the authorization request from the merchant 140 The authorization request from the merchant 140 includes various data regarding the identity of the payment account number, the type and amount of the transaction, merchant data information, and additionally the geographic origin of the request for authorization.

Upon receiving the authorization request from the merchant 140 and the second authentication of the user 150, the managing computer system 110 determines if the PAN associated with the mobile device 150 has been provided first authentication by instructing the storage device 114 (see, e.g., FIGS. 2 and 3) to locate the information regarding the mobile phone 160 in the authentication table (see, e.g., FIG. 3). If first authentication has been provided for transactions at the merchant 140, the managing computer system 110 permits the financial transaction to be processed. If, however, first authentication has not been granted for transactions at the merchant 140 (e.g., the mobile phone 160 is located in another store), the managing computer system 110 is configured to deny the authorization request.

It should be noted that, in certain embodiments, permitting the payment card transaction to be processed might be in the form of taking no actual action but allowing the transaction to flow as normal.

Similarly, the action to permit denying the authorization request may be in the form of simply denying the authorization request directly by sending a denial message to the merchant 140. Alternatively, the managing computer system 110 can send a notification to the card issuer 120 that the authorization should be denied. In the latter instance, the card issuer 120 may decide to authorize the transaction despite the indication that first authentication has not been provided or if the predetermined time of inactivity has lapsed. This can be done, for example, by way of a set of rules that may be geared towards the type of payment, the type or history of the merchant and/or user, the amount of the transaction, or other factors as may be appropriate to reduce frustration among customers without incurring additional undue risk for fraudulent transactions.

Further, the managing computer system 110 may take action to permit denying of the transaction by communicating, through the card processing network 170, a denial message to the merchant 140 requesting authorization and sending an alert to at least one of the user 150 and the card issuer 120, and then with respect to the user 150, preferably through the mobile device 160, but not limited thereto. For instance, if the mobile device 160 is in a powered off state or has been left behind (e.g., not within the premises of the merchant 140), it may be more effective to communicate the denial through various communication means including telephone calls to various numbers associated with the user/cardholder, alternative mobile devices, e-mail accounts, software alerts or other communications as set up between the user 150 and the card issuer 120, and perhaps identified by the user 150 by order of preference. In this regard, information used to associate or link a payment account number (PAN) with a mobile device 160 can include identifying multiple payment account numbers to be associated with one or more mobile devices. In fact, multiple mobile devices may be associated with a given payment account number, and multiple payment account numbers may be associated with a given mobile device. In this way, a user/cardholder who typically carries one of several mobile devices, or authorizes others who have their own mobile devices (e.g., family members) would not be inconvenienced by having to remember or match which mobile device to a given payment card when carrying or initiating transactions using a particular payment card account.

Further, the managing computer system 110 can take action to permit or deny the transaction by sending an alert to the user/cardholder 150 such that the user 150 may decide to indicate that the transaction is to be authorized or denied, or due to not receiving the alert or not responding because the communication was not received or not detected by the user 150. System defaults can be set up by the card issuer 120 or by the user 150 or by both denying the transaction unless the user 150 authorizes the transaction within a given period of time, or authorizing the transaction unless the user 150 indicates that the transaction is to be denied, each within the given period of time.

Where methods described above indicate certain events occurring in certain orders, the ordering of certain events may be modified. Moreover, while a process depicted as a flowchart, block diagram, etc. may describe the operations of the system in a sequential manner, it should be understood that many of the system's operations can occur concurrently or in a different order. For example, although the flow chart (FIG. 5) illustrating two-stage authentication is disclosed and illustrated herein as receiving, by the managing computer system, a second authentication from the user (at step 240) and then receiving an authorization request from the merchant (step 250), it should be understood that the managing computer system is configured to receive the authentication request prior to or concurrently with the second authentication.

The previous description of the various embodiments is provided to enable any person skilled in the art to make or use the invention recited in the accompanying claims of the disclosed system. While exemplary embodiments of the disclosed system have been particularly shown and described with reference to embodiments thereof, it will be understood by those skilled in the art that many variations, modifications and alternative configurations may be made to the invention without departing from the spirit and scope of exemplary embodiments of the disclosed system. The scope, however, of the method and system for implementing the presently disclosed two-stage authentication on payment account number transactions is limited only by the meets and bounds as articulated in the claims appended hereto.

What is claimed is:

1. A method for two-stage authentication of a user of a mobile device for a payment account number transaction, the method comprising:
associating, in a storage device of a financial transaction system, at least one payment account number of a user with a mobile device of the user;
identifying a location of the mobile device at a particular merchant's physical location;
providing a first authentication of the user of the at least one payment account number for payment transactions with the merchant upon the mobile device entering a premises of the merchant; and
receiving a second authentication, said second authentication received from the user as part of a payment transaction against the at least one payment account number associated with said mobile device at said merchant.

2. The method according to claim 1 further comprising:
receiving, by a managing computer system of the financial transaction system, a request from the merchant for authorization for the payment transaction against the payment account number; and
determining if said first authentication has been provided for said user for payment transactions at said merchant.

3. The method according to claim 1, further comprising:
receiving, by a managing computer system of the financial transaction system, a request from the merchant for authorization for the payment transaction against the payment account number; and
permitting the financial transaction to be processed if said first authentication has been provided.

4. The method according to claim 1, further comprising:
receiving, by a managing computer system of the financial transaction system, a request from the merchant for authorization for the payment transaction against the payment account number; and
denying the authorization request if said first authentication has not been provided.

5. The method according to claim 1, wherein identifying said location of the mobile device includes receiving, from the mobile device, information identifying a wireless local area network of the merchant upon the mobile device entering the premises of the merchant.

6. The method according to claim 5, wherein said first authentication is provided while the mobile device detects the wireless local area network of the merchant.

7. The method according to claim 1, further comprising:
associating, in the storage device of the managing computer system, a plurality of merchants with information identifying their respective wireless local area networks.

8. The method according to claim 7, wherein identifying the location of the mobile device comprises:
receiving information, from the mobile device, regarding at least one wireless local area network detected by said mobile device; and
identifying, in the storage device of the managing computer system, at least one merchant associated with said received wireless local area networks detected by said mobile device.

9. The method according to claim 1, wherein said first authentication for transactions at said merchant is provided on a basis of a user's manual input of said location of said mobile device at said merchant.

10. The method according to claim 1, wherein said first authentication for transactions at said merchant is provided upon a user scanning, via the mobile device, a bar code of an item at said merchant.

11. The method according to claim 5, further comprising:
identifying the merchant whereat the mobile device is located on a basis of the received information that (i) identifies a wireless local area network of the merchant upon the mobile device entering the premises of the merchant, and (ii) indicates the physical location of the mobile device.

12. The method according to claim 1 further comprising:
revoking said first authentication of the user of the at least one payment account number for payment transactions at said merchant upon detection of said mobile device leaving said merchant's premises.

13. The method according to claim 12, wherein said detection of said mobile device leaving said merchant's premises is based upon said mobile device losing detection of the wireless local area network of the merchant.

14. The method according to claim 1, further comprising:
revoking said first authentication of the user of the at least one payment account number at said merchant after a predetermined time of inactivity at said merchant.

15. The method according to claim 14, wherein said predetermined time of inactivity is preset by said user and is merchant specific, said predetermined time of inactivity being stored in said storage device of said financial transaction system.

16. The method according to claim 1, further comprising:
revoking said first authentication of the user of the at least one payment account number at said merchant upon said financial transaction system receiving a new physical location of said mobile device.

17. The method according to claim 16 wherein said new physical location of the mobile device is based upon information received by at least one of (i) a user's manual input of said location on said mobile device, (ii) a detection, by said mobile device, of a wireless local area network of a new merchant, and (iii) bar code information, scanned by the mobile device.

18. The method according to claim 1 wherein the physical location of the mobile device is identified using one of a Global Positioning System, radio-frequency identification, Bluetooth, magnetic field detection, Wi-Fi, and sound-based detection.

19. A financial transaction system for two-stage authentication of a user, comprising:
a mobile device of a user configured to transmit information regarding its geographic location;
a storage device, of a managing computer system, configured to store information associating the mobile device of the user with at least one payment account number of the user;
a computer processing device, of the managing computer system, configured to (i) receive the location information from said mobile device, (ii) identify a merchant whereat the mobile device is located, (iii) provide a first authentication of the user of the at least one payment account number associated with the mobile device for payment transactions against said at least one payment account number at said merchant whereat said mobile device is located and (iv) receive second authentication from the user as part of a financial transaction against the at least one payment account number associated with said mobile device at said merchant.

20. The system according to claim 19 wherein the computer processor provides the first authentication prior to initiation, by the user, of a payment transaction at said merchant.

21. The system according to claim 19 wherein the computer processor identifies the merchant upon the mobile device entering the premises of the merchant.

22. The system according to claim 19, wherein
said location information received by said computer processor of the managing computer system, identifies (i) wireless local area networks of merchants detected by the mobile device and a (ii) a physical location of the mobile device; and
said computer processor identifies said merchant, whereat the mobile device is located, based on said received wireless local area networks detected by said mobile device and said physical location of said mobile device.

22. The system according to claim 22, wherein said computer processor, in order to identify said merchant, queries the storage device for merchant information stored therein that is associated with said received wireless local area networks detected by said mobile device.

23. The system according to claim 19, wherein the geographic location of the mobile device is identified using at least one of a Global Positioning System, Wi-Fi, radio-frequency identification, Bluetooth, magnetic field detection, and sound-based detection.

24. The system according to claim 19 wherein the computer processor revokes said first authentication of the user of the at least one payment account number at said merchant upon the detection of the mobile phone leaving a premises of said merchant.

25. The system according to claim 19 wherein said location of the mobile device is identified on a basis of a detection, by the mobile device, of a wireless local area network of the merchant.

26. The system according to claim 25, wherein the mobile phone is configured to detect the wireless local area network of said merchant upon entering the premises of the merchant.

27. The system according to claim 19, wherein the computer processor identifies the merchant at which the mobile device is located, upon which said first authentication is based, when said user scans, via the mobile device, a bar code of an item in the premises of said merchant.

28. The system according to claim 24, wherein the detection of the mobile device leaving said merchant's premises is based upon losing detection, by said mobile phone, of a wireless local area network of the merchant.

29. The system according to claim 19, wherein the computer processor revokes said first authentication of the user for payment transactions at said merchant after a predetermined time of inactivity at said merchant.

30. The system according to claim 29, wherein said predetermined time of inactivity is preset by said user and is merchant specific, said predetermined time of inactivity being stored in said storage device of said financial transaction system.

31. The system according to claim 19, wherein the computer processor revokes said first authentication of the user for payment transactions at said merchant upon receiving new physical location of said mobile device.

32. The system according to claim 31, wherein the new physical location of the mobile device is based upon information received by at least one of (i) a user's manual input of said location on said mobile device, (ii) a detection, by said mobile device, of a wireless local area network of a new merchant, and (iii) bar code information, scanned by the mobile device.

33. The system according to claim 31 wherein said new physical location of the mobile device is identified using one of a Global Positioning System, radio-frequency identification, Bluetooth, magnetic field detection, Wi-Fi, and sound-based detection

34. A non-transitory computer-readable recording medium having a program stored thereon that causes a processor of a computing device to execute the method of claim 1.
